(19) United States
(12) Patent Application Publication
(10) Pub. No.: US 2024/0235342 A9
(43) Pub. Date: Jul. 11, 2024

(54) METHOD FOR PRODUCING A COIL

(71) Applicant: Rolls-Royce Deutschland Ltd & Co KG, Blankenfelde-Mahlow (DE)

(72) Inventors: Marc LESSMANN, Arnsberg (DE); Peter GRÖPPEL, Erlangen (DE); Thomas GLEIXNER, Herzogenaurach (DE); Martin THUMMET, Neunkirchen am Brand (DE); Markus WILD, Nürnberg (DE); Sunil SREEDHARAN, München (DE)

(21) Appl. No.: 18/278,837

(22) PCT Filed: Feb. 21, 2022
(86) PCT No.: PCT/EP2022/054216

§ 371 Date: Aug. 24, 2023

(30) Foreign Application Priority Data
Feb. 25, 2021 (DE) 10 2021 201 797.5

(51) Int. Cl. H02K 15/04

(52) U.S. Cl. CPC H02K 15/0435

(57) ABSTRACT

A method for producing a coil includes winding a wire in order to produce a wound coil, and stretching the wound coil from an initial state into a stretched state with an increased spread. The method includes providing the wound coil, in the stretched state, with a coating, and transferring the wound coil from the stretched state back into a state of smaller spread.

This application is the National Stage of International Application No. PCT/EP2022/054216, filed Feb. 21, 2022, which claims the benefit of German Patent Application No. DE 10 2021 201 797.5, filed Feb. 25, 2021. The entire contents of these documents are hereby incorporated herein by reference.

### BACKGROUND

The present disclosure relates to a method for producing a coil.

In the case of electric motors and other electric machines, the aim is to continuously improve the target variables of energy efficiency, power-to-weight ratio, reliability, and service life. However, some of these target variables conflict with each other and with other requirements. In vehicle construction, for example, not only energy efficiency but also, especially, installation space requirements due to limited available space are to the fore. For low energy consumption in mobile applications (e.g., in cars or trains), a low weight of the drives is also important. The requirements described apply especially to use in aircraft, where, for example, the future of the electrification of aircraft propulsion systems depends decisively on the power density of the engines or generators to be used.

Any increase in the continuous power density of electric motors is significantly limited by the proportion of conductors in the coil winding.

Many electric machines (e.g., electric motors) include one or more coils that are each mounted on a carrier. Such a carrier, together with the coil, is referred to here as a segment for the sake of simplified reference. As a rule, the service life, performance, and complexity of production are decisively determined by the design of such segments.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, improved electric machines provided.

According to one aspect, a method for producing a coil (e.g., in the form of an electric coil and/or in the form of a mechanical spiral) for a machine (e.g., an electric machine) is provided. The method includes winding a wire in order to produce a wound coil (and optionally the thermal aftertreatment of the wound coil, such as annealing), stretching the already wound coil from an initial state into a stretched state with a spread that is increased in comparison with the initial state, providing the coil, in the stretched state, with a coating (e.g., applying the coating, such as insulation), and transferring the coil from the stretched state back into a state with a spread that is smaller in comparison thereto (e.g., into the initial state with respect to the spread).

This is based on the finding that some coatings (e.g., electrical insulation with particularly good insulation properties) are, for example, brittle and cannot be bent or cannot be bent satisfactorily together with a wire to form a coil (e.g., not to form a coil of any desired shape). Therefore, in the case of typical coils that are usually produced from insulated wire, there is potential for improvement in terms of insulation (e.g., in general the coating). It is thus possible in the method of the present embodiments to use coatings having particularly good insulation properties, and thus enabling the coating to be made relatively thinner and the proportion of conductors to be increased. If the coil were merely stretched and then encapsulated with insulation, giving rise to a firmly cast coil piece, then, in contrast, the coil would sometimes not make optimal use of installation space. This may be overcome by compressing the coil again after coating. In addition, the coil remains flexible during this process, and the coil may therefore be slipped particularly well onto the shaft of the carrier. The coating does not connect adjacent windings to one another.

Winding optionally takes place under the action of heat, and/or the coil is subjected to heat after winding. It is thereby possible to relieve stresses in the material of the wire, thus providing that the coil is particularly dimensionally stable with respect to the initial state and that optimum electrical properties are established by recrystallization of the material structure.

The coating may include or consist of an inorganic material. Such materials are generally not usable or may only be used to a limited extent with conventional winding methods.

Further, the coating may include or consist of a ceramic material. This allows particularly efficient electrical insulation.

As an option, the coating encloses the wire (e.g., completely, such as only with the exception of its ends), for example, in an electrically insulating manner. It is thus possible to electrically insulate adjacent windings from one another.

At least one of the following methods may optionally be used to apply the coating: sol-gel method, hard anodizing, plasma chemical method, anodizing, oxidation, or plasma spraying. This allows particularly efficient coating. Alternatively, painting is also possible, for example.

As already mentioned, during the transfer of the coil from the stretched state back into the state of smaller spread, the coil may be transferred into the initial state with respect to the spread (e.g., as a result of the spring-elastic properties of the coil).

According to one aspect, a method for producing a segment is provided. The method includes providing a carrier having a shaft, a holding portion that adjoins the shaft at one end of the shaft and is configured to secure a coil surrounding the shaft on the shaft, and a further portion that projects laterally from the shaft at an angle thereto at the other end of the shaft. The method further includes slipping a coated coil previously produced in accordance with the above-described method over the further portion onto the shaft of the carrier.

This is based on the finding that a coil slipped over the projecting further portion may be produced in advance with a high degree of dimensional accuracy, while the further portion projecting, for example, on one side may provide sufficiently secure retention of the coil. This provides that it is no longer necessary, for example, to connect (e.g., weld) an initially separate holding element (e.g., in the form of a tooth head) to the carrier after the coil has been slipped on. Such subsequent attachment of a holding element may lead to unwanted cutting edge effects and often necessitates additional tools and production steps. In the case of such subsequently attached holding elements, there is also the difficulty of sufficiently secure attachment. As a rule, dispensing with the holding element would result in a reduced attainable torque. Thus, the proposed segment allows a weight reduction with a simultaneously high power and a particularly precise and thus efficient coil wound with a high conductor filling factor. This makes possible light, efficient, and durable electric machines. The holding portion may project laterally from the shaft on both sides, while the further portion, for example, projects laterally from the shaft on one side. The segment may be assembled with further segments (e.g., to form a stator; by the pole chain method). The carrier of a segment then forms a stator element. The coil has a shape and/or flexibility, thus enabling the coil to follow the profile of the segment from the further portion to the shaft.

The further portion is configured, for example, for connection to one or more adjacent segments (e.g., for connection to two adjacent segments). Thus, the coil may first be slipped over the further portion, after which the further portion is connected to further segments. This additionally secures the coil on the shaft. In this case, for example, the holding portion forms a tooth head, for example. The further portion serves, for example, as a yoke for magnetic field lines generated by the coil. Alternatively or additionally, the holding portion is configured for connection to one or more adjacent segments.

As an option, a protective paper (e.g., in the form of a slot insulation paper) is arranged between the coil and the carrier. The coil may be slipped over the protective paper. Alternatively, the protective paper is inserted into the coil in advance and then slipped over the further portion onto the shaft together with the coil. In this way, it is possible to prevent damage to the coil.

As an option, the shaft merges into the further portion via a rounded portion. This may facilitate slipping the coil from the further portion onto the shaft. Accordingly, the coil may be slipped over the rounded portion.

As an option, the wound coil is stretched and/or compressed at least in some portion or portions, as the wound coil is slipped over the further portion onto the shaft of the carrier. For example, this enables the coil to be guided well around the angle between the further portion and the shaft of the carrier.

According to one aspect, a method for producing a segmented coil carrier for an electric machine is specified. The method includes providing a plurality of segments produced in accordance with the method according to any design described herein, and, optionally, connecting the segments, for example, such that the segments are arranged around a common axis.

### BRIEF DESCRIPTION OF THE DRAWINGS

FIGS. 1A-1C show a carrier and a coil in a plurality of acts in the production of a segment;

FIG. 2 shows one embodiment of a segmented coil carrier having a plurality of segments according to FIG. 1C;

FIGS. 3A-3C show a rounded carrier and a coil in a plurality of acts in the production of a segment having a rounded portion;

FIG. 4 shows one embodiment of a segmented coil carrier having a plurality of segments according to FIG. 3C;

FIGS. 5A-5C show the rounded carrier and the coil in a plurality of acts in the production of the segment according to FIGS. 3A-3C, where further details of the coil of the segment are shown;

FIG. 6 shows one embodiment of a segmented coil carrier having a plurality of segments according to FIG. 5C;

FIG. 7 shows one embodiment of an electric machine in the form of an electric motor having a segmented coil carrier having a plurality of segments according to FIG. 5C;

FIGS. 8A-8D show a plurality of acts in the production of an insulated coil; and

FIG. 9 shows one embodiment of an aircraft in the form of an airplane having a plurality of engines.

### DETAILED DESCRIPTION

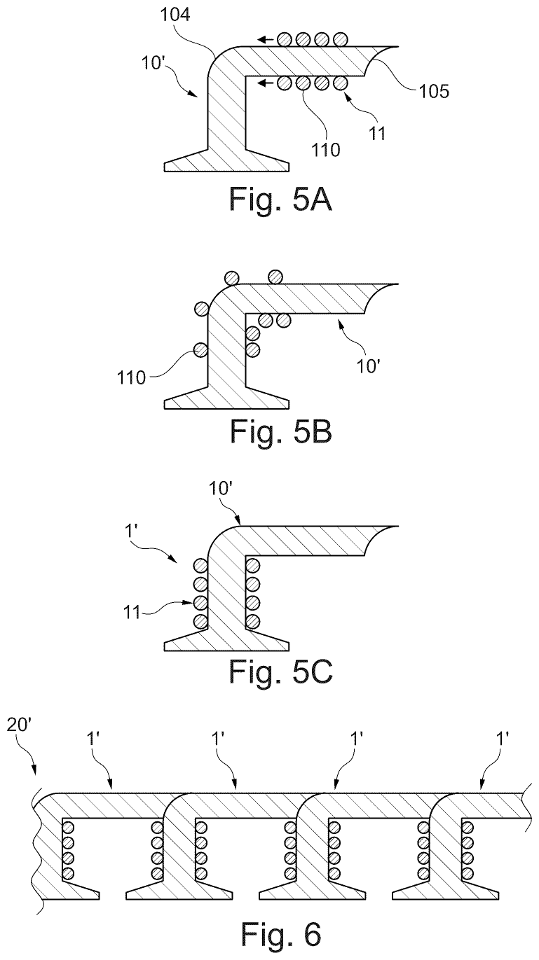

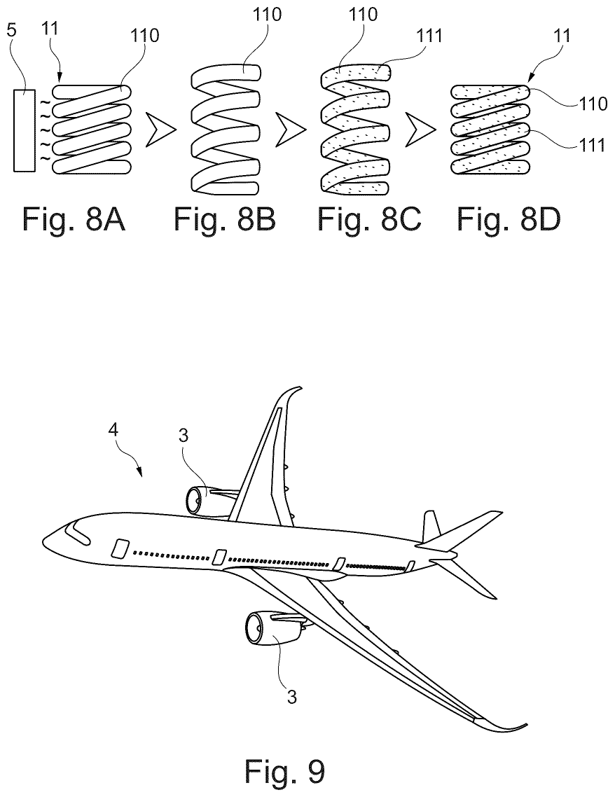

Before a method for producing a coil 11 is explained with reference to FIGS. 8A to 8D and FIGS. 5A-5C, segments 1; 1′ in which such a coil 11 may be used are first described.

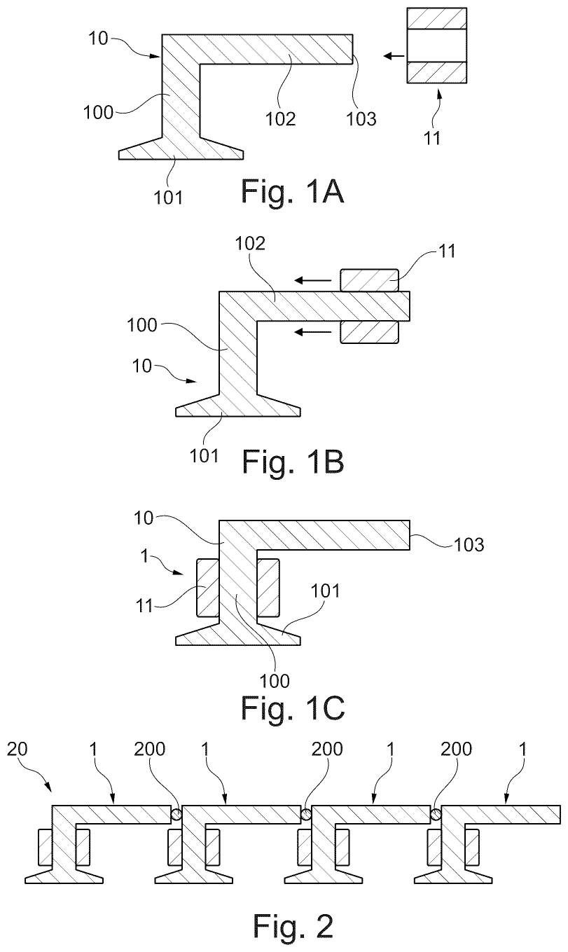

FIG. 1A shows a carrier 10 for a segment and an electrical coil 11. The carrier 10 has a shaft 100, a holding portion 101, and a further portion 102.

The shaft 100 is configured to be surrounded by the coil 11. The shaft 100 has outer surfaces. If the shaft 100 is surrounded by a coil 11, then the coil 11 extends along the outer surfaces around the shaft 100. The outer surfaces of the shaft 100 extend from a first end of the shaft 100 to a second end of the shaft 100 (e.g., parallel to a coil axis around which the coil 11 surrounding the shaft 100 is wound). The shaft 100 may have a depth perpendicularly to this coil axis (e.g., pointing into the image plane of FIG. 1A) that is as large as the width schematically illustrated in FIG. 1A, or is alternatively larger or smaller than the width (e.g., substantially larger). The shaft 100 may, therefore, be configured to be elongate in the direction of the depth perpendicularly to the coil axis.

The holding portion 101 adjoins the shaft 100 at the first end of the shaft 100 and is configured to secure the coil 11 surrounding the shaft 100 on the shaft 100 (e.g., to hold the coil 11 thereon; to fix the coil 11 thereon). The holding portion 101 has a greater width than the shaft 100. Specifically, the holding portion 101 projects from the shaft 100 in two opposite directions. Thus, the coil 11 surrounding the shaft 100 may be securely held thereon by positive engagement. The holding portion 101 projects beyond the coil 11 (e.g., on at least two opposite sides). The holding portion 101 has two flanks that adjoin opposite outer surfaces of the shaft 100. These flanks extend at an angle to one another and at an angle to the coil axis defined by the shaft 100. The flanks are aligned in a V-shape with respect to one another. The shaft 100 and the holding portion 101 together describe the shape of a T. The holding portion 101 projects from the shaft 100 in the form of a mushroom head.

In the present case, the holding portion 101 serves as a tooth head. The holding portion 101 is provided to face a component mounted so as to be movable relative to the carrier 10.

The further portion 102 projects from the shaft 100 on one side at the other, second end of the shaft 100 (e.g., at an angle to the shaft 100, such as at a right angle). The shaft 100 and the further portion 102 are formed such that the coil 11 may be slipped over the further portion 102 onto the shaft 100 in order to mount the coil 11 on the carrier 10. In the present case, the further portion 102 extends in a straight line and in a plane at an angle (e.g., perpendicularly) to the coil axis. Away from the shaft 100, the further portion 102 has an open end 103. The shaft 100 and the further portion 102 together describe the shape of an L.

The coil 11 is shown schematically in block form, for example, and may include a wire wound in a single layer or in a plurality of layers (e.g., a flat conductor), or a plurality of wires or strands wound in one or more layers. The coil 11 is already wound (e.g., already includes one or more turns). For this purpose, a conductor forming the coil 11 may first be wound onto a dummy core, which is particularly easy to do by machine. The coil 11 is then removed from the dummy core and slipped onto the further portion 102.

The slipping on of the coil 11 is explained with reference to FIGS. 1A to 1C. Starting from the unassembled state according to FIG. 1A, the coil 11 is first slipped over the free end 103 of the further portion 102. The coil 11 then initially surrounds the further portion 102, as shown in FIG. 1B.

The coil 11 is then pushed further toward the shaft 100 and, for this purpose, is guided around the angle between the further portion 102 and the shaft 100. For this purpose, the coil 11 is configured with a clearance relative to the further portion 102 and/or to the shaft 100, for example, or the coil 11 is flexible to a corresponding extent, as will be explained in more detail below in conjunction with FIGS. 5A to 5C.

FIG. 1C shows the fully assembled segment 1 with the coil 11 on the shaft 100 of the carrier 10.

The carrier 10 is of one-piece design. The carrier 10 is not composed of a plurality of elements but is formed from a single piece of material. The carrier 10 thus has no joining surfaces. Alternatively, the carrier 10 is laminated (e.g., consists of a plurality of, in particular, congruent, sheet metal blanks). Each of the sheet metal blanks then includes a part of the shaft 100, of the holding portion 101, and of the further portion 102 (e.g., these are always connected integrally to one another, even in the case of a laminated design). In both alternatives, the carrier 10 is free of joining surfaces between the shaft 100 and the holding portion 101, and between the shaft 100 and the further portion 102.

The further portion 102 serves as a connecting portion for attachment to two adjacent, analogously configured segments 1. In this case, the open end 103 provides a connecting region that may be connected directly or, as shown in FIG. 2, by a connecting element 200 to a further segment 1.

Insulating materials may be introduced on the segment 1 (e.g., on the coil 11), before and/or after the mounting of the coil 11. Final fixing of the coil 11 on the carrier 10 and/or of the windings of the coil 11 to one another is optionally carried out by impregnation or encapsulation.

FIG. 2 shows a segmented coil carrier 20 having a plurality of interconnected segments 1 according to FIG. 1C. Here, an open end 103 of a segment 1 is in each case connected to a transition region between the shaft 100 and the further portion 102 of an adjacent segment 1 (e.g., by a connecting element 200). A segmented coil carrier 20 is shown in a linear configuration and may also be used in this form (e.g., for a linear drive). Alternatively, the segmented coil carrier 20 may be of circular configuration. For this purpose, the segments 1 are either fastened to one another at an angle to one another, or the segments 1 are inserted into a sleeve, for example. The connecting elements 200 may provide a rigid or a movable connection. The segmented coil carrier 20 may also be referred to as a pole chain. For example, a stator that uses the pole chain method is then produced from the segmented coil carrier 20. For this purpose, a plurality of segments 1 are arranged in a chain and then brought into a predetermined arrangement relative to one another and fixed relative to one another (e.g., by an outer ring).

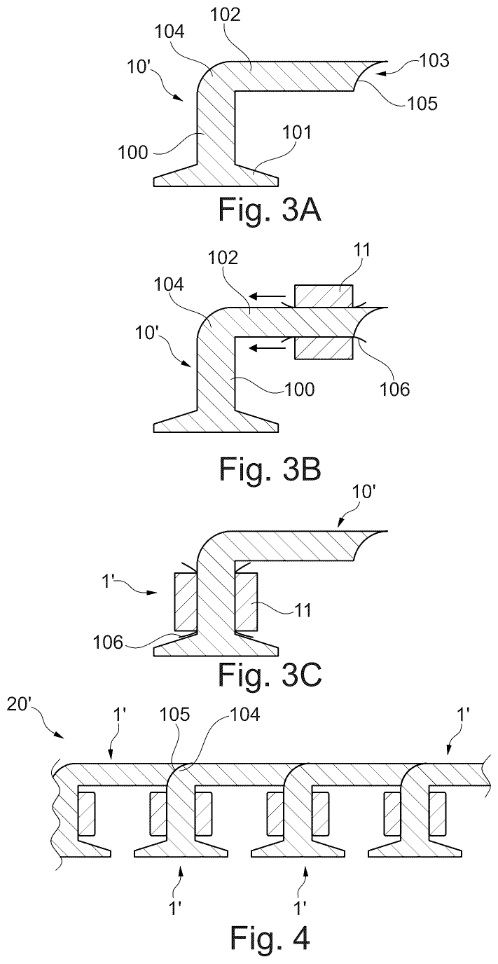

FIGS. 3A to 3C show the mounting of the coil 11 on a carrier 10′ to produce a segment 1′, where, in contrast to the carrier 10 of the segment 1 shown in FIGS. 1A to 1C, the carrier 10′ is configured with two rounded portions 104, 105, and is otherwise configured analogously thereto. Specifically, the carrier 10′ has a rounded portion 104 at the transition between the shaft 100 and the further portion 102. The rounded portion 104 is convex. In the example shown, the rounded portion 104 is in the form of an arc of a circle. The rounded portion 104 has a radius of curvature that corresponds (e.g., exactly, approximately, or at least), for example, to the material thickness of the shaft 100 and/or of the further portion 102. This rounded portion 104 makes it easier to slip the coil 11 over the further portion 102 onto the shaft 100.

FIGS. 3A to 3C accordingly show the slipping (e.g., facilitated slipping) of the coil 11 onto the carrier 10′.

As an option, a protective paper 106 (e.g., in the form of a slot insulation paper) is arranged between the coil 11 and the carrier 10′. The coil 11 may be slipped over the protective paper 106. Alternatively, the protective paper 106 is inserted into the coil 11 in advance and then slipped over the further portion 102 onto the shaft 100 together with the coil 11. In this way, it is possible to prevent damage to the coil 11 (e.g., to a coating of the coil 11).

The carrier 10′ has a further rounded portion 105 that, in the present case, is formed at the open end 103 of the further portion 102. This rounded portion 105 is concave. This rounded portion 105 is configured to match the rounded portion 104 at the transition between the shaft 100 and the further portion 102. The shapes of the two rounded portions 104, 105 fit into one another. As a result, a plurality of segments 1′ may be brought into surface-to-surface contact with one another, without an air gap, at the matching rounded portions 104, 105.

FIG. 4 shows a corresponding segmented coil carrier 20′ having a plurality of segments 1′. The segmented coil carrier 20′ allows particularly efficient guidance of the magnetic field lines.

FIGS. 5A to 5C show the same carrier 10′ as FIGS. 3A to 3C, where the coil 11 is specifically illustrated as a single-layer winding of a wire 110. The coil 11 is, for example, illustrated with a spiral-shaped geometry. By way of example, the coil 11 has the structure of a spiral spring. The coil 11 may be elastically deformed by the action of a force and returns elastically to its previous configuration once the force ceases to act.

The wire 110 has a flexibility that makes it possible to elastically change the distances between individual windings of the coil 11. This makes it particularly easy to slip the coil 11 over the rounded portion 104 onto the shaft 100. For example, the individual turns of the coil 11 are not fixed (e.g., adhesively bonded) to one another.

As an option, a piece of flat material (e.g., an insulation paper) is arranged between the carrier 10′ and the coil 11 to make it easier to slip the coil 11 on and, where applicable, to prevent damage to an insulation layer of the coil 11.

FIG. 6 once again shows the segmented coil carrier 20′ having the plurality of segments 1′. The coil 11 adjoins the holding portion 101 at the first end of the shaft 100 and adjoins the further portion 102 at the second end of the shaft 100.

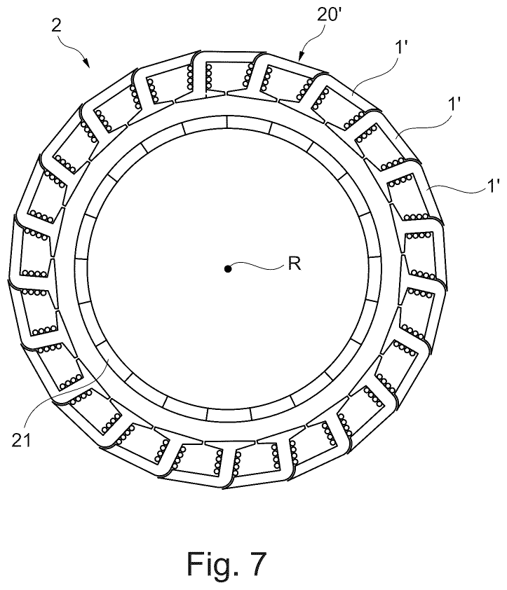

While the segmented coil carrier 20′ is shown in a linear arrangement in FIG. 6, FIG. 7 shows the segmented coil carrier 20′ in an annular arrangement. The individual segments 1′ are, for example, arranged concentrically around an axis of rotation R. The segments 1′ are fixed to one another and/or fixed relative to one another by a holding device (e.g., a sleeve). The segmented coil carrier 20′ forms a stator of an electric machine 2 in the form of an electric motor. The electric machine 2 further includes a rotor 21 arranged within the segmented coil carrier 20′. The rotor 21 is rotatable about the axis of rotation R relative to the segmented coil carrier 20′. The rotor 21 includes a number of permanent magnets. The rotor 21 may be rotated relative to the stator about the axis of rotation R by an electric current flow through the coils 11.

As an option, tooth heads of the segmented coil carrier 20′ are of asymmetrical design, as illustrated in FIG. 7 by the uppermost segment 1′ by a dashed line.

FIGS. 8A to 8D illustrate a method for coating a coil 11 (e.g., the coil 11) for the segments 1; 1′ described herein.

In this case, initially, at least one bare, non-insulated wire 110 is wound to form the coil 11. Since it is not necessary to pay attention to a coating already present before winding, winding may be simplified, and the wire 110 may be wound more precisely, with more force. In addition, winding is not limited by maximum bending radii or yield points of a coating, and therefore, the wire 110 may be brought very precisely into a predetermined shape (e.g., into a rectangular or polygonal shape). These advantages apply to all types of wires or strands but the advantages apply especially in the case of solid individual wire windings. As an option, the wire 110 has a rectangular cross-sectional profile but may also assume any form of cross-sectional profile. The wire 110 may also be configured as a flat conductor.

The coil 11 is then initially present in an initial state. This initial state is shown in FIG. 8A. Winding optionally takes place using heat, and/or the wound coil 11 is subjected to final annealing. It is thereby possible to reduce stresses in the material, thus providing that the coil 11 retains its wound shape in accordance with the initial state and that the electrical properties are optimized by recrystallization of the material structure. A heater 5 for applying heat to the wire 110 and/or the coil 11 is illustrated schematically in FIG. 8A.

Starting from the initial state according to FIG. 8A, the wound coil 11 is then stretched (e.g., reversibly stretched) and thus transferred into a stretched state that, in comparison with the initial state, has a greater spread (e.g., a greater distance between adjacent turns). The stretched state is shown in FIG. 8B.

In the stretched state, the coil 11 is then provided with a coating 111 (e.g., in the form of an electrical insulation, see FIG. 8C). As a result of the spreading, the coating 11 may be applied to all the surfaces of the wire 110. The coating may include a ceramic. By way of example, the coating 110 electrically insulates adjacent turns of the coil 11 from one another.

In this state, the wire 110 of the coil 11 is also freely accessible from all sides, thus enabling the applied coating 111 to be checked particularly well without the need to employ complex methods for this purpose. This also makes possible particularly high quality standards.

The coated coil 11 is then transferred from the stretched state into a state with a spread that is comparatively smaller in comparison thereto, optionally into the initial state in respect of the spread. This transfer may be accomplished, for example, by the inherent flexibility of the coil 11 (e.g., which is true to shape in the initial state), for example, by releasing the ends of the coil 11 that have been pulled apart for spreading. This final state of the finished, coated coil 11 is illustrated in FIG. 8D.

Since each piece of the wire 110 is substantially less deformed between the stretched state and the initial state than during the winding of the coil 11, the mechanical loads on the coating 111 during the return to the initial state are relatively low. This permits an improved service life of the coil 11, as well as the use of particularly efficient coatings that would not normally have been usable owing to their brittleness, wrinkling, or other material properties. This is particularly important because coatings having particularly good electrical properties may usually be mechanically loaded only to a very limited extent (e.g., ceramics). It is also possible to dispense with steps that might otherwise be necessary for healing defects in the coating since the coating is now subject to only slight mechanical stress.

For example, the coating 111 includes or consists of an inorganic material. One of the following methods, for example, may be used for coating: sol-gel method, hard anodizing, plasma chemical method, anodizing, oxidation, or plasma spraying.

As an option, the coil 11 is composed of a plurality of individual conductors that are spread apart for coating, as described, and are subsequently welded to one another.

The finished coil 11 according to FIG. 8D may then be slipped onto the carrier 10; 10; see, for example, FIGS. 5A to 5C. For example, this coil 11 has an elasticity that makes it easier to slip the coil 11 (e.g., turn by turn) over the further portion 102 of the carrier onto the shaft 100.

FIG. 9 shows an aircraft 4 in the form of an airplane. The aircraft 4 includes wings and a plurality of engines 3. Each engine of the plurality of engines 3 includes an electric motor according to FIG. 7.

Since the coil 11 is wound in advance, separately from the carrier 10; 10′, the coil 11 may be produced in a manner that is particularly efficient and true to shape. Since it is not necessary to dispense with the holding section 101, good performance in terms of a torque and a cogging torque may be achieved. Since the holding element does not have to be fixed subsequently, there are no cutting edge effects in this respect, and complex geometries for fixing the holding element (e.g., dovetail positive joints) are not necessary. The production tolerances may also be improved thereby. It is also possible to reduce waste during production. The one-piece configuration allows a particularly robust embodiment and a long service life. By virtue of the simple geometry, it is also possible to significantly simplify production.

The invention is not restricted to the embodiments described above, and various modifications and improvements may be made without departing from the concepts described herein. Any of the features may be used separately or in combination with any other features, unless they are mutually exclusive, and the disclosure extends to and includes all combinations and subcombinations of one or more features that are described herein.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for producing a coil for a machine, the method comprising:
winding a wire such that a wound coil is produced;
stretching the wound coil apart from an initial state into a stretched state with an increased spread;
providing the wound coil, in the stretched state, with a coating; and
transferring the wound coil from the stretched state back into a state of smaller spread,
wherein the coating comprises or consists of a ceramic material.

2. The method of claim 1, wherein the winding takes place under an action of heat, the wound coil is subjected to heat after the winding, or a combination thereof.

3. The method of claim 1, wherein the coating comprises or consists of an inorganic material.

4. The method of claim 1, wherein the coating encloses the wire in an electrically insulating manner.

5. The method of claim 1, further comprising applying the coating using a sol-gel method, hard anodizing, a plasma chemical method, anodizing, oxidation, or plasma spraying.

6. The method of claim 1, wherein, during the transferring of the wound coil from the stretched state back into the state of smaller spread, the wound coil is transferred into the initial state with respect to the spread.

7. A method for producing a segment for an electric machine, the method comprising:
providing a carrier having a shaft, a holding portion, that adjoins the shaft at one end of the shaft and is configured to secure a coil surrounding the shaft on the shaft, and a further portion that projects from the shaft at an angle thereto at the other end of the shaft; and
slipping a coil over the further portion onto the shaft of the carrier,
wherein the coil is produced according to a method for producing the coil, the method for producing the coil comprising:
winding a wire such that the coil is produced;
stretching the coil apart from an initial state into a stretched state with an increased spread;
providing the coil, in the stretched state, with a coating; and
transferring the coil from the stretched state back into a state of smaller spread, and
wherein the coating comprises or consists of a ceramic material.

8. The method of claim 7, wherein the shaft merges into the further portion via a rounded portion, and the coil is slipped over the rounded portion.

9. The method of claim 7, wherein the coil is stretched at least in some portion or portions as the coil is slipped over the further portion onto the shaft of the carrier.

10. A method for producing a segmented coil carrier for an electric machine, the method comprising:
providing a plurality of segments, providing the plurality of segments comprising producing a segment of the plurality of segments, the producing comprising:
providing a carrier having a shaft, a holding portion that adjoins the shaft at one end of the shaft and is configured to secure a coil surrounding the shaft on the shaft, and a further portion that projects from the shaft at an angle thereto at the other end of the shaft; and
slipping a coil over the further portion onto the shaft of the carrier, wherein the coil is produced according to a method for producing the coil, the method for producing the coil comprising:
winding a wire such that the coil is produced;
stretching the coil apart from an initial state into a stretched state with an increased spread;
providing the coil, in the stretched state, with a coating; and
transferring the coil from the stretched state back into a state of smaller spread, and wherein the coating comprises or consists of a ceramic material; and
connecting the plurality of segments, such that the plurality of segments are arranged around a common axis.

11. The method of claim 8, wherein the coil is stretched at least in some portion or portions as the coil is slipped over the further portion onto the shaft of the carrier.

12. The method of claim 2, wherein the coating comprises or consists of an inorganic material.

13. The method of claim 2, wherein the coating encloses the wire in an electrically insulating manner.

14. The method of claim 3, wherein the coating encloses the wire in an electrically insulating manner.

15. The method of claim 3, further comprising applying the coating using a sol-gel method, hard anodizing, a plasma chemical method, anodizing, oxidation, or plasma spraying.

16. The method of claim 4, further comprising applying the coating using a sol-gel method, hard anodizing, a plasma chemical method, anodizing, oxidation, or plasma spraying.

17. The method of claim 3, wherein, during the transferring of the wound coil from the stretched state back into the state of smaller spread, the wound coil is transferred into the initial state with respect to the spread.

18. The method of claim 5, wherein, during the transferring of the wound coil from the stretched state back into the state of smaller spread, the wound coil is transferred into the initial state with respect to the spread.

19. The method of claim 16, wherein, during the transferring of the wound coil from the stretched state back into the state of smaller spread, the wound coil is transferred into the initial state with respect to the spread.
